(19) United States
(12) Patent Application Publication
(10) Pub. No.: US 2011/0069943 A1
(43) Pub. Date: Mar. 24, 2011

(54) Apparatus for Heating Fluids

(76) Inventors: Michael LUPPOLD, Dettenheim (DE); Martin Meeh, Wiernsheim (DE); Alexander Dauth, Maulbronn (DE); Joerg Weigold, Karlsruhe (DE); Hans-Peter Etzkorn, Bruchsal (DE); Juergen Kochems, Illingen (DE); Klaus Lehmann, Oberderdingen (DE)

(21) Appl. No.: 12/859,447

(22) Filed: Aug. 19, 2010

(30) Foreign Application Priority Data
Aug. 21, 2009 (DE) 10 2009 038 978.4

(51) Int. Cl. H05B 3/78

(52) U.S. Cl. 392/488

(57) ABSTRACT

The invention relates to an apparatus for heating fluids, comprising a housing in which a duct runs, through which the fluid to be heated can flow and which leads from a housing opening for fluid to enter to a housing opening for fluid to exit. According to the invention, the duct extends in several convolutions along a housing wall carrying at least one heater housing, in which at least one electric heating element is arranged.

The invention relates to an apparatus for heating fluids, having a housing comprising an inner chamber through which the fluid to be heated can flow and which has a housing opening for fluid to enter and a housing opening for fluid to exit.

Such apparatuses are required, for example, in vehicles in order to heat aqueous fluids, generally mixtures made of water and an antifreeze agent, such as glycol, In the process the problem arises that relatively large amounts of energy must be introduced as uniformly and quickly as possible into the fluid to be heated. Selective heating of the fluid should be avoided to the extent possible, because this may result in local overheating and disintegration of the fluid.

It is therefore an object of the present invention to show a way as to how thermal energy can be introduced quickly and uniformly into a fluid to be heated.

### SUMMARY OF THE INVENTION

An apparatus according to the invention has a housing in which a duct runs, through which the fluid to be heated can flow and which leads from a housing opening for fluid to enter to a housing opening for fluid to exit. To this end, the duct extends in several convolutions along a housing wall carrying at least one heater housing, in which at least one electric heating element is arranged. Advantageously, the housing wall in this way may form a heat distribution plate, which distributes the heat generated by the heating element or elements over a large surface. The heat that is generated can thus be quickly and uniformly absorbed by a fluid flowing along the housing wall in the flow duct having a plurality of convolutions.

The housing opening for fluid to enter preferably has a larger cross-sectional surface than the duct, with a larger width being particularly preferred. In this way, the flow rate of the fluid to be heated is increased upon entering the heater. Advantageously, in this way better heat exchange can be achieved. Just like the cross-sectional surface of a duct, the cross-sectional surface of an opening is measured perpendicular to the flow direction. The cross-sectional surface of the inlet opening is therefore the free opening surface.

The housing is preferably composed of at least two housing parts, between which the flow duct runs. The two housing parts can be bonded to each other in a fluid-tight manner, such as by welding them together. However, it is also conceivable that a seal is pressed between the housing parts and a fluid-tight connection of the two housing parts is achieved in this way. For this purpose, the housing parts can be held together by screws, so that a sealing ring present between the housing parts is pressed. The two housing parts preferably each have a plate-shaped wall, which forms the bottom or cover of the housing.

According to an advantageous refinement of the invention, at least one of the two housing parts has a structure on the inside thereof for forming the duct. The structure may be a groove in the housing part, for example, and/or may be formed by inwardly extending elevations which delimit the duct. Such a structure can particularly advantageously be configured in a casting. For this reason, at least one of the two housing parts is a casting, particularly the housing part having the two openings.

The housing parts preferably form the walls of the duct. As a result, a fluid flowing through the duct comes in contact with the two housing parts and can efficiently absorb heat from them.

### BRIEF DESCRIPTION OF THE DRAWINGS

Further details and advantages of the invention will be described based on embodiments with reference to the attached drawings. Identical and corresponding parts are denoted with agreeing reference numerals. Shown are:

FIG. 1: An embodiment of an apparatus according to the invention;

FIG. 2: a further view of FIG. 1;

FIG. 3: a sectional view along the intersecting line AA of FIG. 2;

FIG. 4: a further embodiment of an apparatus according to the invention;

FIG. 5: a side view of FIG. 4;

FIG. 6: a sectional view of FIG. 4 along the intersecting line AA;

FIG. 7: a sectional view of FIG. 5 along the intersecting line CC;

FIG. 8: a side view of FIG. 4;

FIG. 9 a sectional view of FIG. 4 along BB; and

FIG. 10: a further embodiment of an apparatus according to the invention.

### DETAILED DESCRIPTION

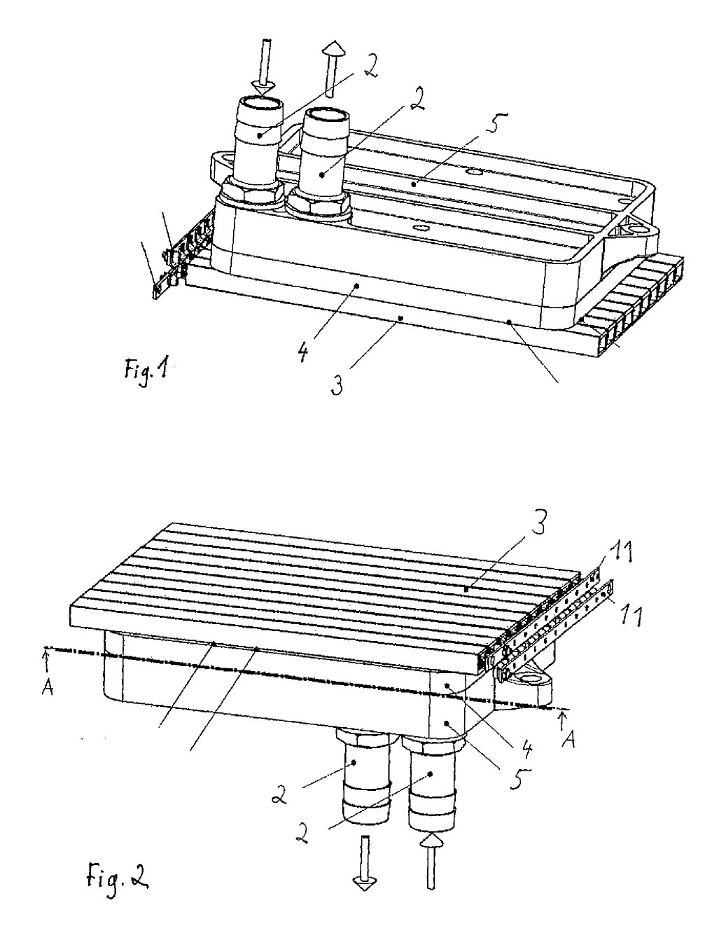

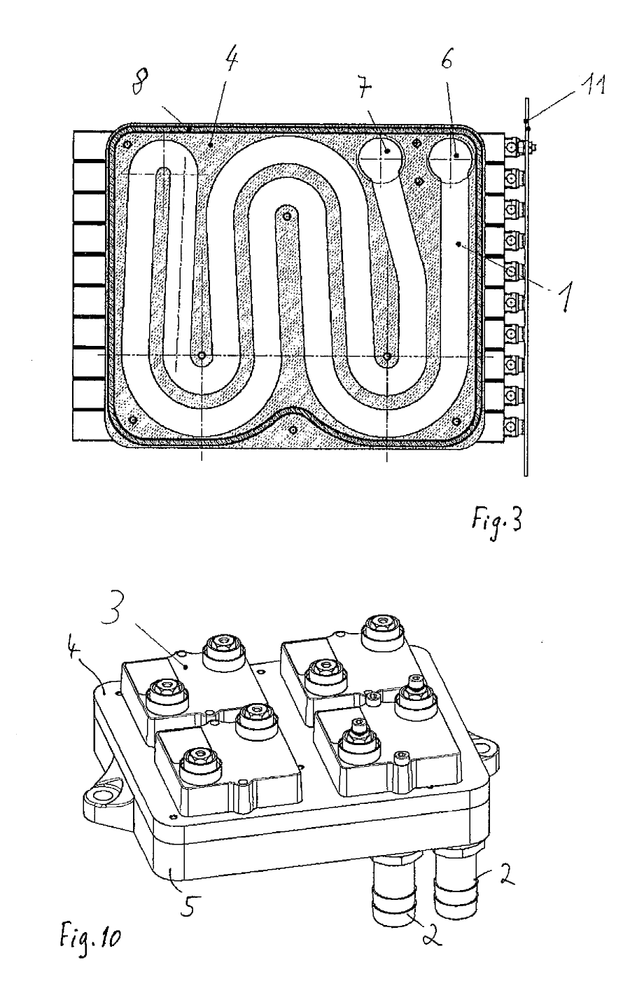

The apparatus illustrated in FIGS. 1 to 3 is used to heat aqueous fluids in vehicles, in particular mixtures made of water and antifreeze agent, such as glycol. The apparatus has a housing in which a duct 1 runs, through which the fluid to be heated can flow and which leads from a housing opening 6 for fluid to enter to a housing opening 7 for fluid to exit. A nozzle 2, such as a screw-in threaded nozzle, is inserted in each of the two housing openings 6, 7. The duct 1 extends in several convolutions along a housing wall carrying a plurality of heater housings 3, which are designed as rectangular tubes and in each of which at least one, preferably a plurality of, electric heating elements are arranged. The two housing openings 6, 7 have a larger cross-sectional surface than the duct 1. A fluid to be heated thus flows more quickly in the duct than in the lines connected to the openings. The larger cross-sectional surface of the opening 6, 7 is achieved in the illustrated exemplary embodiment in that the opening 6, 7 has a larger width than the duct 1.

In the illustrated embodiment, the housing is composed of two housing parts 4, 5, between which the meander-shaped flow duct 1 runs. A sealing ring 8 is pressed between the two housing parts 4, 5 connected to each other by screws. One or both housing parts 4, 5 can be produced by casting, for example, in particular by die casting or injection molding. The duct 1 can advantageously be formed by an inner structure in a housing part 4, 5 made by casting, the structure being a groove in the illustrated exemplary embodiment.

One of the two housing parts 4 carries the heating elements present in the heater housings 3, while the other housing part 5 comprises the housing openings 6, 7 for fluid to enter and fluid to exit. The housing openings 6, 7 are thus arranged in a housing wall which is located opposite of the housing wall carrying the heater housing 3.

In the illustrated embodiment, the heater housing 3 is designed as an extruded section, which is fastened to a housing part 4, for example by soldering, welding or by way of a heat-conducting adhesive. The housing wall of this housing part 4 forms a heat distribution plate, thereby bringing about an areal distribution of the heat generated by the heating elements, so that it can be absorbed by the fluid flowing through the duct.

Instead of fastening the extruded section to the housing, it is also possible for the extruded section to form a housing wall and thus a housing part, which closes the housing, for example as a housing cover. For example, the extruded section may comprise a plate connecting the individual tube housings and forming a housing wall.

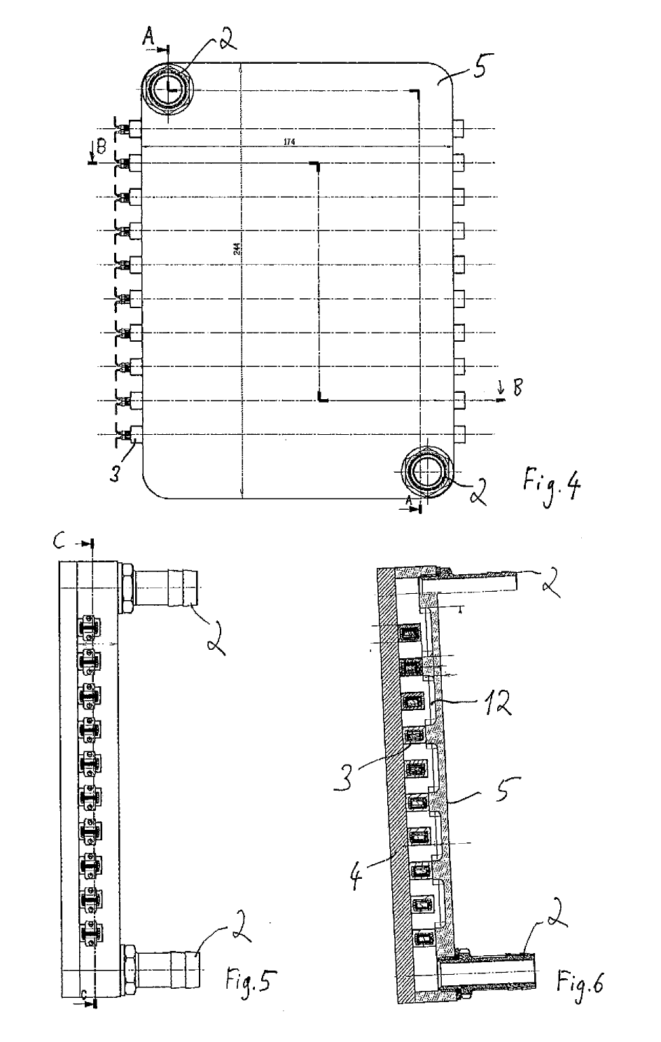

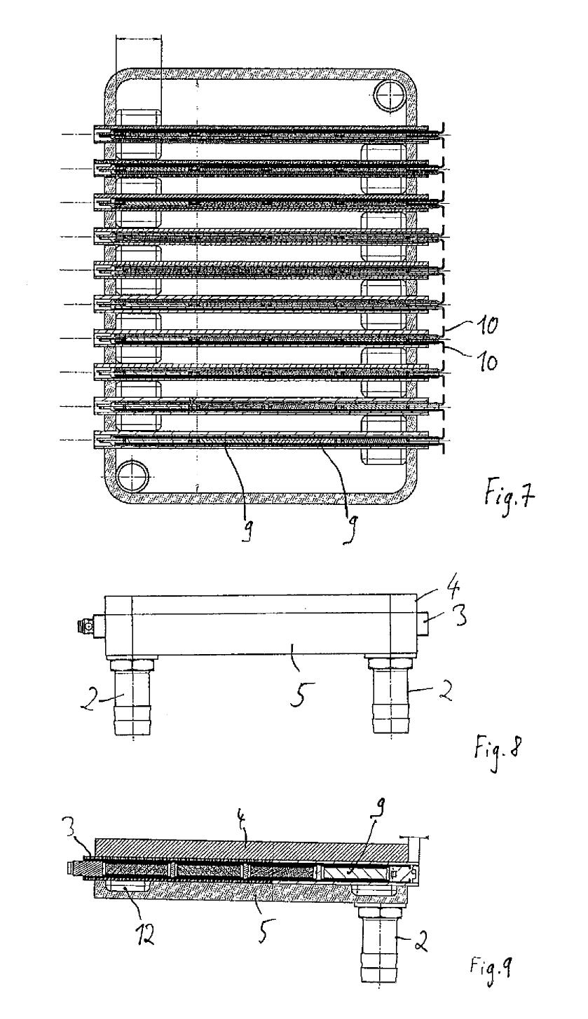

FIGS. 4 to 9 illustrate a further exemplary embodiment, which likewise comprises a housing which is composed of two parts 4, 5 and in which a duct 1 through which a fluid to be heated can flow runs between two housing openings. Similar to the exemplary embodiment described above, the duct 1 extends in several convolutions along a housing wall carrying a plurality of heater housings 3, which are designed as tubes and in each of which a plurality of electric heating elements 9 are arranged. Contrary to the exemplary embodiment described above, however, the heater housings 3 are not arranged on the outside of the housing of the apparatus through which the fluid can flow, but instead in the inner chamber through which the fluid can flow. During operation, a fluid to be heated thus surrounds the heater housings 3 and is guided in a meander shape along the individual heater housings 3. In this way, advantageously even better heat coupling of the heater housings 3 to the fluid to be heated can be achieved.

The heating elements 9 arranged in the heater housings 3 are PTC heating elements, preferably ceramic heating elements, for example based on barium titanate. At a critical temperature, PTC heating elements exhibit a sudden increase in the electric resistance thereof, whereby overheating is largely excluded. The heating elements 9 are arranged in the heater housings 3 between two contact plates 10, which are electrically insulated with respect to the heater housings 3 and protrude from the heater housings 3. As is apparent in particular from FIG. 2, the contact plates 10 are bent over at the protruding ends and connected to bus bars 11 running transversely to the longitudinal direction thereof for power supply purposes. Just like the contact plates 10, the bus bars 11 can be designed as sheet metal strips. In the illustrated exemplary embodiment, the contact plates 10 are screwed to the bus bars 11. The contract plates 10 may also be connected with the bus bars 11 by welding or plugging.

In order to improve the heat coupling of the heating elements 9 to the heater housings 3, the heater housings 3 can be pressed after inserting the PTC elements. This can be done before assembling the housing through which the fluid can flow. It is also possible to press the heater housings 3 in that a pressing force is applied onto the two housing parts 4, 5, between which the heater housings 3 are arranged. In this case, care should be taken that the contact plates 10 are arranged in the heater housings 3 such that the surfaces thereof face the housing upper side or housing lower side onto which the pressing force is applied.

A housing part 4 can be formed particularly advantageously by an extruded section which comprises a plurality of tube housings for the heating elements, the tube housings being connected by a plate. This housing part 4 can be connected to a second housing part 5, which has recesses for the heater housings 3 in the side walls thereof. The inside of the second housing part 5 rests against the heater housings 3, so that they form walls of the duct 1. The second housing part 5, which is preferably produced by casting or deep drawing and comprises the two housing openings 6, 7, has a depression 12 on the inside thereof in front of every other recess, fluid being able to pass through this depression under the heater housing 3 located thereon, whereby a duct 1 having a meander-shaped flow path is achieved.

FIG. 10 shows a further exemplary embodiment of an apparatus for heating fluids, which differs from the exemplary embodiment illustrated in FIGS. 1 to 3 substantially only by the design of the heater housings 3 and the heating elements arranged therein. The heater housings 3 of the exemplary embodiment illustrated in FIG. 10 are not extruded sections, but cast or deep-drawn housings 3, which are fastened to the housing wall of the apparatus by way of screws. The resistors arranged in the heater housings 3 can be made of resistance wire, for example, and can be connected to the onboard power system of a vehicle by way of screw or plug contacts.

### REFERENCE NUMERALS

1 Duct
2 Nozzle
3 Heater housing
4 Housing part
5 Housing part
6 Housing opening
7 Housing opening
8 Sealing ring
9 Heating element
10 Contact plates
11 Bus bars
12 Depression

What is claimed is:

1. An apparatus for heating fluids, comprising
a housing in which a duct runs, through which the fluid to be heated can flow and which leads from a housing opening for fluid to enter to a housing opening for fluid to exit,
wherein the duct extends in several convolutions along a housing wall carrying at least one heater housing, in which at least one electric heating element is arranged.

2. The apparatus according to claim 1, wherein the housing is composed of two housing parts between which the flow duct runs.

3. The apparatus according to claim 2, wherein a seal is pressed between the housing parts.

4. The apparatus according to claim 2, wherein at least one of the housing parts is a casting.

5. The apparatus according to claim 4, wherein the two housing openings are arranged in the cast housing part.

6. An apparatus according to claim 1, wherein the housing opening for fluid to enter has a larger cross-sectional surface than the duct.

7. An apparatus according to claim 1, wherein the housing opening for fluid to enter has a larger width than the duct.

8. An apparatus according to claim 1, wherein the heater housing is integral with the housing wall.

9. An apparatus according to claim 1, wherein the housing wall forms a heat distribution plate.

10. An apparatus according to claim 1, wherein the two housing openings are arranged in a housing wail located opposite of the housing wall carrying the heater housing.

11. An apparatus according to claim 1, wherein a threaded nozzle is screwed into each of the two housing openings.

12. An apparatus according to claim 1, wherein the heater housing is a tube, in particular a rectangular tube.

13. An apparatus according to claim 1, wherein a plurality of heater housings are formed by a single extruded section.

14. The apparatus according to claim 13, wherein the extruded section forms the housing wall.

15. An apparatus according to claim 1, wherein the at least one heating element is a PTC heating element.

16. The apparatus according to claim 15, wherein the PTC heating element is arranged in the heater housing between two contact plates that are electrically insulated with respect to the heater housing and protrude from the heater housing.

17. The apparatus according to claim 16, wherein the contact plates are connected to bus bars running transversely to the longitudinal direction thereof for power supply purposes.

18. An apparatus according to claim 1, wherein the at least one heater housing is arranged on an outside of the housing.
